(19) United States
(12) Patent Application Publication
(10) Pub. No.: US 2024/0085703 A1
(43) Pub. Date: Mar. 14, 2024

(54) Electronic Devices With Gaze Trackers

(71) Applicant: Apple Inc., Cupertino, CA (US)

(72) Inventors: Chih Jen Chen, San Jose, CA (US); Brian S Lau, Sacramento, CA (US); Cameron A Harder, San Francisco, CA (US); David A Kalinowski, Davis, CA (US)

(21) Appl. No.: 18/355,965

(22) Filed: Jul. 20, 2023

Related U.S. Application Data
(60) Provisional application No. 63/404,612, filed on Sep. 8, 2022.

(51) Int. Cl. G02B 27/01; F21V 8/00; G02B 5/32; G02B 6/02; G02B 27/00

(52) U.S. Cl. CPC G02B 27/0172; G02B 5/32; G02B 6/0006; G02B 6/02033; G02B 6/02061; G02B 27/0093; G02B 2027/0138; G02B 2027/0178

(57) ABSTRACT

A head-mounted device may include a housing having openings that receive lenses. Displays may output images. Waveguides that overlap the lenses may receive the images from the displays and may direct the images to eye boxes that are aligned with the lenses. Infrared light sources such as infrared light-emitting diodes or lasers may be used to supply infrared light to the waveguides. Each waveguide may have multiple localized output couplers that overlap the lenses. The localized output couplers of each lens each direct a beam of the infrared light out of the waveguide towards an eye surface in the eye box associated with that lens to produce an eye glint. A gaze tracker infrared camera may captured images of the eye glints to determine a user's point of gaze.

This application claims the benefit of provisional patent application No. 63/404,612, filed Sep. 8, 2022, which is hereby incorporated by reference herein in its entirety.

### FIELD

This relates generally to electronic devices, and, more particularly, to electronic devices such as head-mounted devices.

### BACKGROUND

Electronic devices may use displays to present images to a user. In some devices, it may be desirable to track the eyes of a user.

### SUMMARY

A head-mounted device may include a housing having openings that receive lenses. Displays may output images. Waveguides that overlap the lenses may receive the images from the displays and may direct the images to eye boxes that are aligned with the lenses.

Infrared light sources such as infrared light-emitting diodes or lasers may be used to supply infrared light to waveguides on left and right sides of the device. Each waveguide may have multiple localized output couplers.

The localized output couplers may overlap the lenses. During operation, each of the localized output couplers of each lens may direct a beam of the infrared light out of the waveguide towards an eye surface in the eye box associated with that lens to produce an eye glint. A gaze tracker infrared camera may captured images of the eye glints to determine a user's point of gaze.

If desired, light guides formed from optical fibers or molded polymer waveguides may distribute infrared light to a series of light emitter locations along the edge of a lens opening in the housing, thereby forming a ring of light emitters for a gaze tracker running along the periphery of the lens. This arrangement allows the light emitters for each lens to be provided with light from a common infrared light source such as a common light-emitting diode or laser.

### BRIEF DESCRIPTION OF THE DRAWINGS

FIG. 1 is a top view of an illustrative head-mounted device in accordance with an embodiment.

FIG. 2 is a front view of a portion of an illustrative head-mounted device in accordance with an embodiment.

FIG. 3 is a top view of an illustrative waveguide having localized output couplers configured to extract light from the waveguide to provide glint illumination to an eye box in accordance with an embodiment.

FIGS. 4, 5, 6, and 7 are cross-sectional top views of illustrative waveguide input coupler arrangements for a gaze tracker light source in accordance with embodiments.

FIGS. 8 and 9 are cross-sectional top views of illustrative localized waveguide output coupler arrangements for a gaze tracker light source in accordance with embodiments.

FIG. 10 is a front view of a portion of an illustrative head-mounted device having waveguides such as fiber optic waveguides for a gaze tracker light source in accordance with an embodiment.

### DETAILED DESCRIPTION

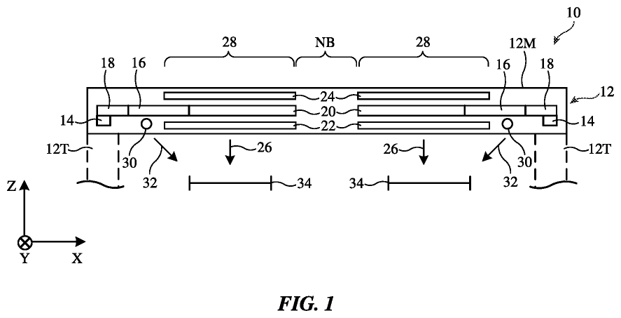

FIG. 1 is a schematic diagram of an illustrative electronic device of the type that may include gaze trackers. Device 10 of FIG. 1 may be a head-mounted device such as goggles, glasses, a helmet, and/or other head-mounted device or may be other suitable equipment. In an illustrative configuration, which is described herein as an example, device 10 is a pair of glasses.

As shown in the illustrative top view of device 10 of FIG. 1, device 10 may have a housing such as housing 12 (sometimes referred to as a head-mounted support structure or head-mounted support). Housing 12 may include main frame portion 12M (sometimes referred to as the main frame, lens frame, or eyeglasses frame) such as portion 12M and side portions 12T (sometimes referred to as temples or side supports). Main portion 12M may have a nose-bridge portion NB that has a shape configured to rest on the user's nose. When housing 12 is worn on a head of a user, the user's eyes are present in eye boxes 34 and receive images from device 10 in directions 26. Frame portion 12M supports left and right lenses 28 in alignment with respective left and right eye boxes 34. Lenses 28 are transparent, so that rear-world objects may be viewed through lenses 28 from eye boxes 34. Accordingly, a user may view the real world and virtual objects simultaneously.

Device 10 may have displays 14 such as projector displays. Waveguides 16 may have input couplers 18 and output couplers 20 (e.g., input and output couplers based on holograms, surface relief gratings, etc.). Input couplers 18 receive images from displays 14. Waveguides 16 guide the image light from displays 14 laterally (along the X dimension of FIG. 1) and thereby provide the images from input couplers 18 to output couplers 20. Output couplers 20 supply the display images to eye boxes 34 in directions 26 for viewing by the user. Each lens 28 (which may sometimes be referred to as an eyeglass lens) may, if desired, have a negative bias lens 22 and a compensating positive bias lens 24. Output couplers 20 may be located between lenses 22 and 24. Lenses 24 may be used to place the images from displays 14 at a desired virtual image distance (e.g., 1-2 m). Lenses 22 may be used to compensate for the lens powers of lenses 24 so that real-world images may be viewed through lenses 28 normally. If desired, lenses 28 may include removable prescription lenses and/or a user's prescription may be incorporated into lenses 22 (as examples).

During operation of device 10, a user may view real-world objects and through lenses 28 while displays 14 are displaying virtual objects. Gaze trackers may be used to monitor the user's point of gaze (e.g., to identify which real-world objects are being viewed by the user and/or to identify which virtual objects are being viewed by the user). This allows device 10 to coordinate the content being displayed by displays 14 with real-world content being viewed and/or otherwise helps device 10 respond to the activities of the user.

Gaze trackers for device 10 have light sources. The light sources emit infrared light that reflects from the surfaces of the user's eyes in eye boxes 34, creating discrete reflections called glints (sometimes referred to as gaze tracker glints or eye glints). The gaze trackers also contain gaze tracking infrared cameras such as cameras 30. During operation, gaze tracker cameras 30 gather images in directions 32 from eye boxes 34. In particular, cameras 30 on the left and right sides of device 10 (or in nose bridge portion NB) capture images of the user's eyes and therefore capture images of the glints on the user's eyes. The glint images are then processed by the gaze trackers to determine the direction in which the user's eyes are pointed (sometimes referred to as the user's direction of view or point of gaze).

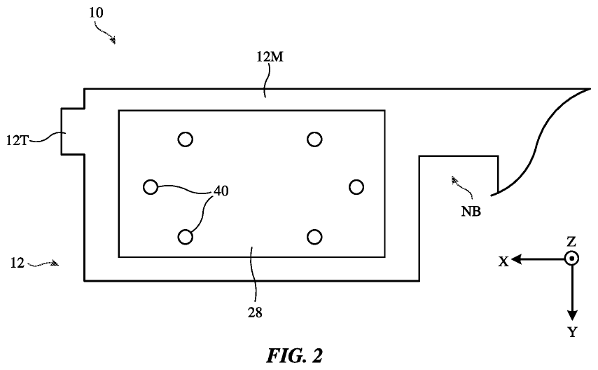

FIG. 2 is a front view of an illustrative right portion of device 10. As shown in FIG. 2, housing portion 12M serves as an eyeglasses frame (e.g., an opaque frame) that supports lenses such as lens 28. The infrared light source for the gaze tracker in the example of FIG. 2 has six light emitters 40 arranged in a ring around a central portion of lens 28. Each of light emitters 40 emits a respective beam of light towards the right eye box 34 (located behind device 10 in the configuration of FIG. 2). Each of these beams, in turn, is reflected from the surface of the user's eye in the eye box as a glint and is imaged by the right gaze tracker camera 30.

Placing glint beam emitters such as light emitters 40 within the clear aperture of lens 28 helps ensure that the glints formed by the beams of light from emitters 40 will reflect from the user's eye at satisfactorily steep angles (e.g., so that the glints are visible to camera 30). In an illustrative configuration, emitters 40 are formed from localized output couplers on waveguide 16 (e.g., output couplers that each occupy only a relatively small portion of the surface area of lens 28). As shown in FIG. 2, emitters 40 overlap lens 28 with this type of arrangement, but do not overlap any opaque frame structures formed by housing portion 12M. The localized output couplers of emitters 40 are configured to couple infrared light from waveguide 16 towards eye box 34 while being transparent to visible light. This makes emitters 40 invisible or nearly invisible to the naked eye. Accordingly, a user may view real-world objects through lenses 28 without interference from emitters 40. There are six emitters 40 in the example of FIG. 2, but more emitters or fewer emitters may be provided for each eye box 24, if desired.

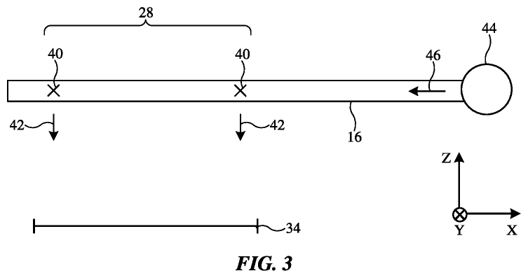

FIG. 3 is a top view of an illustrative gaze tracker light source. The light source has an infrared light-emitting diode 44 or other light-emitting device (e.g., an infrared laser) that emits infrared light 46 (e.g., infrared light at a wavelength of at least 900 nm, 940 nm, or other suitable infrared wavelength) into a waveguide such as waveguide 16 (e.g., the same waveguide being used to transport images from display 14 of FIG. 1). Light 46 is coupled into the edge of waveguide 16 and is transported to a location that is overlapped by eye box 34 and lens 28, where light 46 is then coupled out of waveguide 16 by localized output couplers associated with light emitters 44 to form infrared light beams 42. Light beams 42 illuminate discrete locations on the eye of the user in eye box 34 and thereby create glints that are captured by gaze tracker camera 30. The localized output couplers of emitters 44 are preferably transparent to visible light, so that a user may view real-world objects through lens 28 without viewing emitters 40.

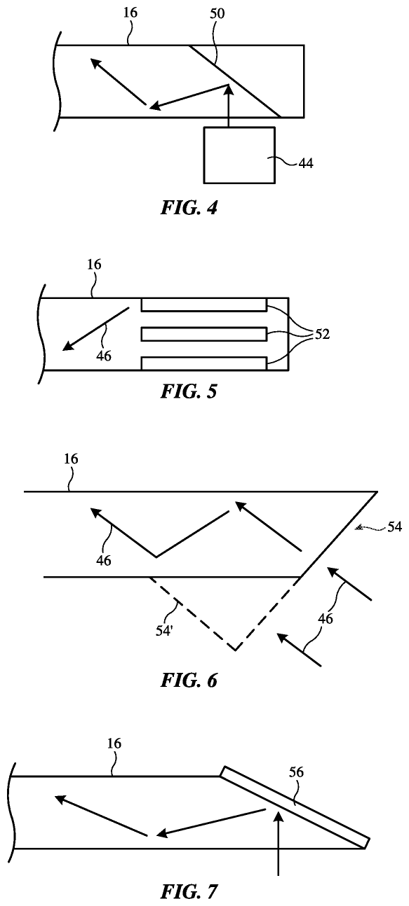

Illustrative configurations for coupling infrared light 46 into waveguide 16 from light-emitting diode 44 are shown in FIGS. 4, 5, 6, and 7. Once light 46 is coupled into waveguide 16, light 46 will be guided within waveguide 16 in accordance with the principal of total internal reflection. In this way, light 46 will travel along the length of waveguide 16 from light-emitting diode 44 at the edge of device 10 to the portion of waveguide 16 overlapping lens 28.

In the example of FIG. 4, an input coupler for infrared light 46 has been formed from louver 50 in waveguide 16. Louver 50 may be formed from a thin-film reflector that is reflective to infrared light 46. Louver structures such as louver 50 may be formed by depositing a thin-film coating onto a block of waveguide material, attaching additional waveguide material to the block, and subsequently cutting a waveguide with a desired angular orientation and shape from the block. Louver 50 may be configured to couple light 46 into waveguide 16 from the outwardly-facing or inwardly-facing surface of waveguide 16.

As shown in FIG. 5, an input coupler for infrared light 46 may be formed on the front or rear surface of waveguide 16 or may be embedded in waveguide 16 (see, e.g., illustrative input coupler locations 52 of FIG. 5). The input coupler of FIG. 5, which may receive light 46 from the front or rear surface of waveguide 16, may be formed from a surface relief grating (e.g., a lithographically patterned coating of a dielectric such as silicon nitride deposited on the surface of waveguide 16) or a hologram (e.g., a hologram formed from exposing a photosensitive polymer to a hologram pattern).

In the FIG. 6 arrangement, light 46 is coupled into waveguide 16 by an input coupler formed by angled surface 54 (beveled surface) on waveguide 16 (or on a separate or integral waveguide protrusion 54′). Arrangements of the type shown in FIG. 6 may sometimes be referred to as prism coupler arrangements and may be used to couple light 46 into waveguide 16 from the outwardly facing or inwardly facing side of waveguide 16.

FIG. 7 shows how light 46 may be coupled into waveguide 16 using an input coupler formed from a reflective coating 56 (sometimes referred to as a reflector) on a beveled surface of waveguide 16. Reflective coating 56 may be configured to couple light 46 into waveguide 16 from the outwardly facing side or inwardly facing side of waveguide 16.

Other types of input coupler arrangements may be used to couple infrared light 46 from infrared light-emitting diode 44 into the edge of waveguide 16, if desired. The arrangements of FIGS. 4, 5, 6, and 7 are illustrative.

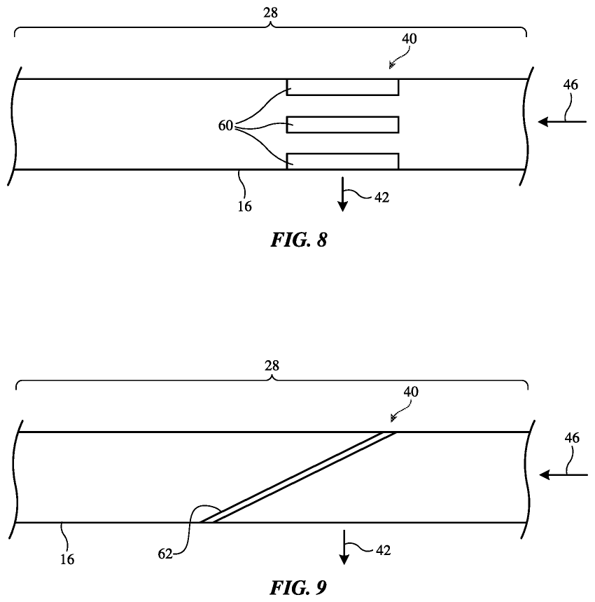

FIGS. 8 and 9 are cross-sectional views of illustrative light emitters 40 formed from localized output couplers in a portion of waveguide 16 overlapping lens 28. These localized output couplers may each occupy a relatively small portion (e.g., less than 5% or less than 2%) of the total area occupied by lens 28.

As shown in FIG. 8, a localized output coupler for infrared light 46 may be formed on the front or rear surface of waveguide 16 or may be embedded in waveguide 16 (see, e.g., illustrative output coupler locations 60 of FIG. 8). The output coupler of light emitter 40 of FIG. 8 may be formed from a surface relief grating (e.g., a lithographically patterned coating of a dielectric such as silicon nitride deposited on the surface of waveguide 16) or a hologram (e.g., a hologram formed by exposing a photosensitive polymer on the surface or in the core of waveguide 16 to a hologram pattern). The localized output coupler of light emitter 40 of FIG. 8 may exhibit high reflectivity (e.g., a reflectivity of at least 70%, at least 85%, or at least 95%) at the infrared wavelength associated with infrared light 46 (e.g., a wavelength of at least 900 nm or other infrared wavelength) and may exhibit a high transmission (e.g., a transmission of at least 70%, at least 85%, at least 95%, or at least 99%) at visible light wavelengths (e.g., 500 nm, as an example). During operation, infrared light 46 that is coupled out of waveguide 16 by the output coupler of light emitter 40 forms eye glint beam 42.

FIG. 9 shows how light emitter 40 may be formed from an output coupler based on louver 62. Louver 62 may be formed from a reflector (e.g., a thin-film interference filter formed from a stack of transparent dielectric layers such as inorganic dielectric layers of alternating refractive index values). Louver 62 may be angled with respect to the surfaces of waveguide 16. As with the localized output coupler of FIG. 8, louver 62 (e.g., the thin-film interference filter forming louver 62) may exhibit high infrared reflectivity (e.g., a reflectivity of at least 70%, at least 85%, or at least 95% at the infrared wavelength associated with infrared light 46, which may be a wavelength of at least 900 nm or other infrared wavelength) and may exhibit a high transmission (e.g., a transmission of at least 70%, at least 85%, at least 95%, or at least 99% at visible light wavelengths such as a wavelength of 500 nm).

With the illustrative arrangements of FIGS. 8 and 9, light emitters 40 are configured to efficiently couple infrared light 46 out of waveguide 16 towards eye box 32 as glint light beams 42, while exhibiting sufficient visible light transparency to help prevent light emitters 40 from being visible to a user as the user views real-world objects through lens 28.

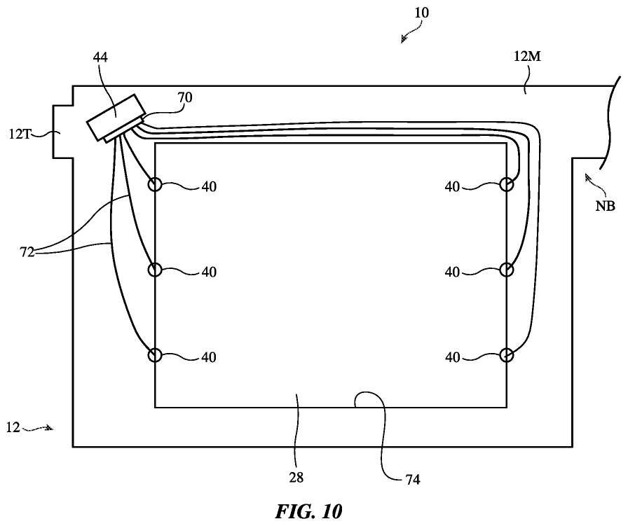

Another illustrative arrangement for forming light emitters 40 of device 10 is shown in FIG. 10. In this type of arrangement, an infrared light source such as an infrared laser or infrared light-emitting diode 44 supplies infrared light to splitter 70. Splitter 70, in turn, provides respective portions of the infrared light from to respective light guides 72. Light guides 72 may be formed from a material such as polymer or glass that is transparent to infrared light.

With one illustrative configuration, light guides 72 are fiber-optic waveguides (sometimes referred to as optical fibers) each of which has an infrared-transparent core of polymer or glass surrounded by a lower-index infrared-transparent cladding of polymer or glass. The optical fibers may be embedded in polymer or other material forming housing 12M and/or may be routed within hollow portions of housing 12M. The output of each optical fiber forms a respective light emitter 40. As shown in FIG. 10, these light emitters 40 may be located along interior edge 74 of the lens opening in housing portion 12M that receives lens 28 (e.g., along the outer edge of lens 28).

With another illustrative configuration, light guides 72 may be formed from molded polymer waveguide structures. These structures may include molded polymer cores surrounded by molded polymer cladding. If desired, the cores may be formed from a first shot of infrared-transparent polymer and the cladding may form a second, lower-index shot of infrared-transparent polymer that surrounds the first shot. In some embodiments, the second shot of polymer may form some or all of portion 12M. The outline of lens 28 may be rectangular (as shown in the example of FIG. 10), may have a teardrop shape, may be oval, may be circular, or may have any other suitable lens shape. As with light emitters 40 of FIG. 2, light emitters 40 formed from the outputs of waveguides 72 of FIG. 10 may be arranged in a ring around a central portion of lens 28.

To help protect the privacy of users, any personal user information that is gathered by sensors may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A head-mounted device, comprising:
a head-mounted housing;
a lens in the head-mounted housing through which real-world objects are visible from an eye box;
a display configured to output an image;
a waveguide configured to provide the image to the eye box;
a gaze tracker camera;
an infrared light source configured to supply infrared light to the waveguide; and
output couplers on the waveguide that overlap the lens and that each provide a respective beam of the infrared light to the eye box to produce an eye glint for the gaze tracker camera.

2. The head-mounted device defined in claim 1 wherein the output couplers each comprise a louver.

3. The head-mounted device defined in claim 1 wherein the output couplers each comprise a hologram.

4. The head-mounted device defined in claim 1 wherein the output couplers each comprise a surface relief grating.

5. The head-mounted device defined in claim 1 wherein the infrared light source is configured to supply the infrared light at a wavelength of at least 900 nm.

6. The head-mounted device defined in claim 1 wherein the output couplers are configured to be transparent to visible light.

7. The head-mounted device defined in claim 1 further comprising an input coupler configured to couple the infrared light from the infrared light source to the waveguide.

8. The head-mounted device defined in claim 7 wherein the input coupler comprises an input coupler selected from the group consisting of a hologram and a surface relief grating.

9. The head-mounted device defined in claim 7 wherein the input coupler comprises a louver.

10. The head-mounted device defined in claim 7 wherein the input coupler comprises a reflector on a beveled surface of the waveguide.

11. Glasses, comprising:
an eyeglasses frame having a lens opening;
a lens in the lens opening that includes a positive bias lens and a negative bias lens, wherein real-world objects are viewable through the lens from an eye box;
a waveguide having a portion between the positive bias lens and the negative bias lens, wherein the waveguide provides an image to the eye box;
an infrared light source configured to supply infrared light to the waveguide; and
a plurality of localized output couplers in the portion of the waveguide, wherein each of the localized output couplers directs a respective beam of the infrared light out of the waveguide and towards the eye box to produce an eye glint.

12. The glasses defined in claim 11 further comprising an infrared gaze tracking camera directed towards the eye box to capture images of the eye glints.

13. The glasses defined in claim 12 further comprising a display configured to provide the image to the waveguide.

14. The glasses defined in claim 13 wherein the localized output couplers are arranged in a ring around a center of the lens.

15. The glasses defined in claim 14 wherein the localized output couplers are configured to transmit visible light.

16. The glasses defined in claim 14 wherein each of the localized output couplers comprises a respective louver.

17. The glasses defined in claim 14 wherein each of the localized output couplers comprises a respective hologram.

18. The glasses defined in claim 14 wherein each of the localized output couplers comprise a respective surface relief grating.

19. Glasses, comprising:
an eyeglass frame having an opening;
a lens in the opening through which real-world objects are visible from an eye box;
a display configured to output an image;
a waveguide configured to provide the image to the eye box;
a gaze tracker camera;
an infrared light source configured to supply infrared light; and
a plurality of light guides each of which receives a respective portion of the infrared light and each of which has an output at an edge of the opening that provides a respective infrared light beam to the eye box to produce an eye glint for the gaze tracker camera.

20. The glasses defined in claim 19 wherein each of the light guides comprises a respective optical fiber.

21. The glasses defined in claim 19 wherein each of the light guides comprises a molded polymer core embedded in polymer cladding.
